(19) United States
(12) Patent Application Publication
(10) Pub. No.: US 2026/0186533 A1
(43) Pub. Date: Jul. 2, 2026

(54) PEDESTAL MOUNTS AND DOCKS FOR MOBILE DEVICES AND METHODS OF MAKING AND USING

(71) Applicant: National Products, Inc., Seattle, WA (US)

(72) Inventors: Jeffrey D. Carnevali, Seattle, WA (US); Stefan Michael Gottschalk, Seattle, WA (US)

(21) Appl. No.: 19/008,180

(22) Filed: Jan. 2, 2025

(51) Int. Cl. G06F 1/16

(52) U.S. Cl. CPC G06F 1/1632; G06F 1/166

(57) ABSTRACT

A mount for a mobile device includes a mounting arm for coupling a dock; an axle coupled to the mounting arm; a first tube arrangement including a first tube and at least a pair of axle posts extending from the first tube; a second tube arrangement including a base and a second tube extending from the base; and a lever disposed along a one of the first tube or the second tube, wherein the lever includes a lever post disposed along an end portion; wherein another one of the first tube or the second tube defines a first cutout extending around at least 50% of its circumference to receive the lever post and permit travel of the lever post along the first cutout so that a dock, when attached, is rotatable about two different axes when the lever post is received in the first cutout.

### FIELD

The present invention is directed to mounts for a mobile device. The present invention is also directed to mounts with or without docks for a mobile device.

### BACKGROUND

Mobile devices, such as smartphones, cellular or mobile phones, tablets, personal data assistants, and other portable devices, are now ubiquitous. Mounts and cradles can be used to protect the mobile device, to mount the mobile device onto a surface or object, or to provide power, or data to or from, the mobile device, or any combination thereof.

### BRIEF SUMMARY

One embodiment is a mount for a mobile device. The mount includes a dock configured for coupling to the mobile device; a mounting arm coupled to the dock; an axle coupled to the mounting arm and configured for rotation of the dock about the axle; a first tube arrangement including a first tube and at least a pair of axle posts extending from the first tube, wherein each of the axle posts defines an axle opening for receiving the axle with a portion of the mounting arm disposed around the axle and between the axle posts; a second tube arrangement including a base and a second tube extending from the base; and a lever disposed along a first one of the first tube or the second tube, wherein the lever includes a first end portion with a lever post disposed along the first end portion, a second end portion opposite the first end portion, and at least one fulcrum arm coupled to the first one of the first tube or the second tube and disposed between the first end portion and the second end portion of the lever; wherein a second one of the first tube or the second tube defines a first cutout extending around at least 50% of a circumference of the second one of the first tube or the second tube, wherein the first cutout is configured to receive the lever post and permit travel of the lever post along the first cutout; wherein the first one of the first tube or the second tube is configured for insertion into the second one of the first tube or the second tube to receive the lever post in the first cutout, wherein the second one of the first tube or the second tube is configured to engage the second end portion of the lever to bias the lever post outward into the first cutout, wherein the mount is configured for the dock to be rotatable, relative to the base of the second tube arrangement, about two different axes when the lever post is received in the first cutout.

In at least some embodiments, the second one of the first tube or second tube further defines a second cutout configured to receive and hold the lever post at a selected position along the circumference of the second one of the first tube or the second tube, wherein the mount is configured for the dock to be rotatable, relative to the base of the second tube arrangement, about one axis when the lever post is received in the second cutout.

In at least some embodiments, the dock defines a docking button indentation configured to receive a docking button disposed on, or coupled to, a back surface of the mobile device or of a case containing the mobile device. In at least some embodiments, the dock includes a cradle configured for receiving the mobile device.

In at least some embodiments, the mount further includes a cover configured to cover at least a portion of the second tube arrangement. In at least some embodiments, the cover defines an opening configured for accessing the lever post of the lever through the cover when the lever post is rotated to align with the opening.

In at least some embodiments, the axle includes a first portion and a second portion, wherein the first portion receives a part of the second portion to form the axle. In at least some embodiments, the mount further includes a cable extendable through a portion of the mount for coupling the mobile device to a power or data source.

Another embodiment is a mount for a mobile device. The mount includes a mounting arm configured for coupling a dock thereto; an axle coupled to the mounting arm and configured for rotation about the axle; a first tube arrangement including a first tube and at least a pair of axle posts extending from the first tube, wherein each of the axle posts defines an axle opening for receiving the axle with a portion of the mounting arm disposed around the axle and between the axle posts; a second tube arrangement including a base and a second tube extending from the base; and a lever disposed along a first one of the first tube or the second tube, wherein the lever includes a first end portion with a lever post disposed along the first end portion, a second end portion opposite the first end portion, and at least one fulcrum arm coupled to the first one of the first tube or the second tube and disposed between the first end portion and the second end portion of the lever; wherein a second one of the first tube or the second tube defines a first cutout extending around at least 50% of a circumference of the second one of the first tube or the second tube, wherein the first cutout is configured to receive the lever post and permit travel of the lever post along the first cutout; wherein the first one of the first tube or the second tube is configured for insertion into the second one of the first tube or the second tube to receive the lever post in the first cutout, wherein the second one of the first tube or the second tube is configured to engage the second end portion of the lever to bias the lever post outward into the first cutout, wherein the mount is configured for the dock, when coupled thereto, to be rotatable, relative to the base of the second tube arrangement, about two different axes when the lever post is received in the first cutout.

In at least some embodiments, the mount further includes the dock configured for coupling to the mobile device, wherein the dock is removably coupled or coupleable to the mounting arm. In at least some embodiments, the dock defines a docking button indentation configured to receive a docking button disposed on, or coupled to, a back surface of the mobile device or of a case containing the mobile device. In at least some embodiments, the dock includes a cradle configured for receiving the mobile device.

In at least some embodiments, the second one of the first tube or second tube further defines a second cutout configured to receive and hold the lever post at a selected position along the circumference of the second one of the first tube or the second tube, wherein the mount is configured for the dock, when coupled thereto, to be rotatable, relative to the base of the second tube arrangement, about one axis when the post is received in the second cutout.

In at least some embodiments, the mount further includes a cover configured to cover at least a portion of the second tube arrangement. In at least some embodiments, the cover defines an opening configured for accessing the lever post of the lever through the cover when the lever post is rotated to align with the opening.

In at least some embodiments, the axle includes a first portion and a second portion, wherein the first portion receives a part of the second portion to form the axle. In at least some embodiments, the mount further includes a cable extendable through a portion of the mount for coupling the mobile device to a power or data source.

Yet another embodiments is a system that includes any of the mounts described above, as well as the mobile device.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1A is a schematic perspective side view of one embodiment of a mount for a mobile device, according to the invention;

FIG. 1B is a schematic perspective side view of the mount of FIG. 1A from another angle, according to the invention;

FIG. 1C is a schematic perspective side view of another embodiment of a mount for a mobile device, according to the invention;

FIG. 1D is a schematic perspective side view of the mount of FIG. 1A with the cover removed, according to the invention;

FIG. 1E is a schematic perspective side view of the mount of FIG. 1A with the cover removed from a different angle, according to the invention;

FIG. 1F is a schematic perspective side view of the mount of FIG. 1A with the cover removed and the first and second tube arrangements separated, according to the invention;

FIG. 1G is a schematic close-up, cross-sectional view of the mount of FIG. 1A with the cover removed, according to the invention;

FIG. 1H is a schematic close-up, cross-sectional view of the mount of FIG. 1A with the cover removed and the first tube arrangement partially inserted into the second tube arrangement, according to the invention;

FIG. 1I is a schematic close-up, cross-sectional view of the mount of FIG. 1A with the cover removed and the first tube arrangement fully inserted into the second tube arrangement, according to the invention;

FIG. 2 is a schematic perspective side view of a third embodiment of a mount for a mobile device, according to the invention;

FIG. 3A is a schematic perspective view of one embodiment of a cradle for use as a dock in the mount of FIG. 2, according to the invention;

FIG. 3B is a schematic perspective view of the cradle of FIG. 3A from another angle, according to the invention;

FIG. 4A is a schematic perspective back view of a mobile device contained within a case and having a docking button coupled thereto, according to the invention;

FIG. 4B is a schematic perspective back view of the cradle of FIG. 3A with the mobile device of FIG. 4A received by the cradle, according to the invention;

FIG. 5A is a schematic side view of another embodiment of a dock with a latch lock in an unlocked position, according to the invention;

FIG. 5B is a schematic perspective cross-sectional view of the dock of FIG. 5A with the latch lock in a locked position, according to the invention; and

FIG. 6 is a schematic perspective view of one embodiment of a cradle for use as a dock in the mount of FIG. 1A, according to the invention.

### DETAILED DESCRIPTION

The present invention is directed to mounts for a mobile device. The present invention is also directed to mounts with or without docks for a mobile device.

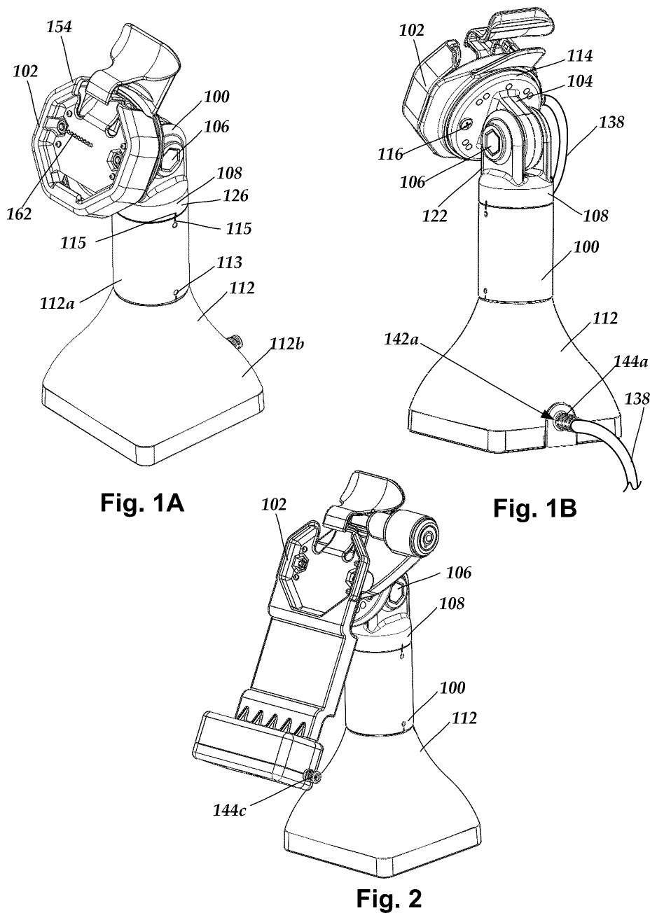

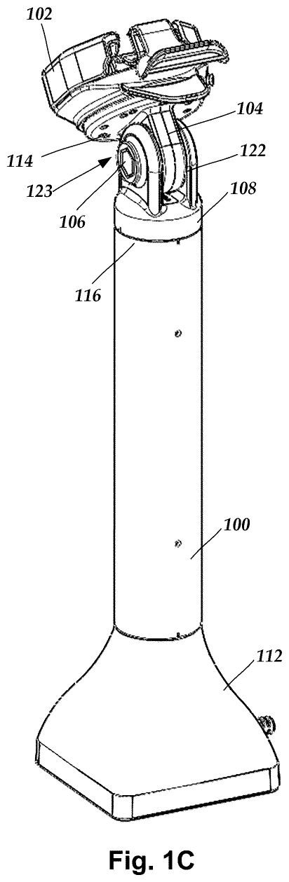

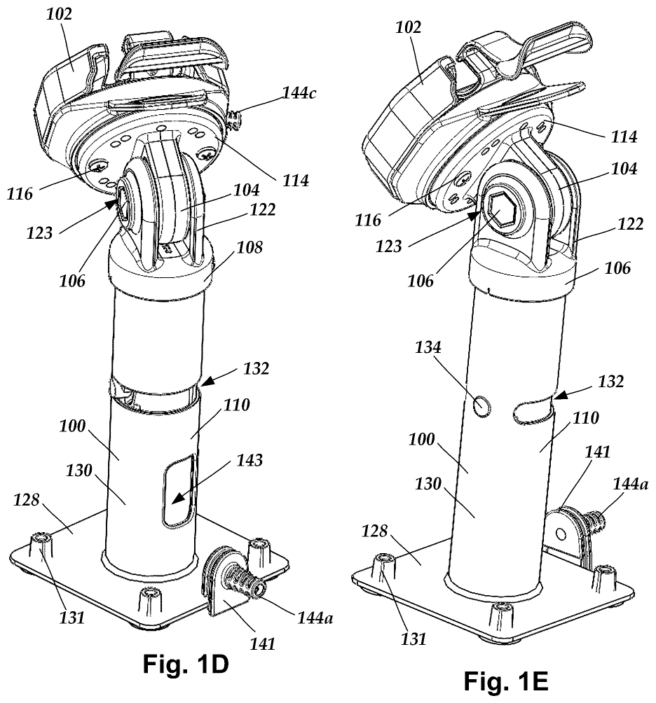

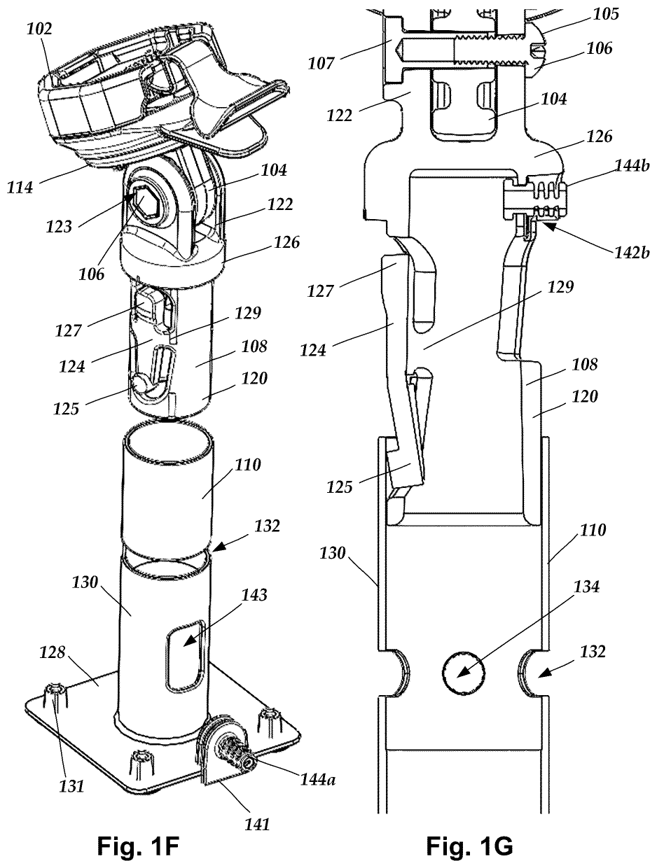

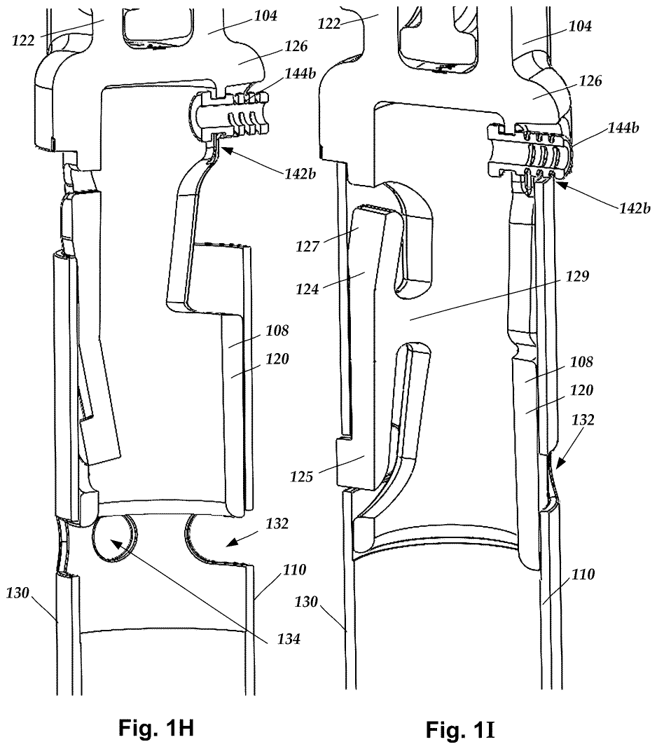

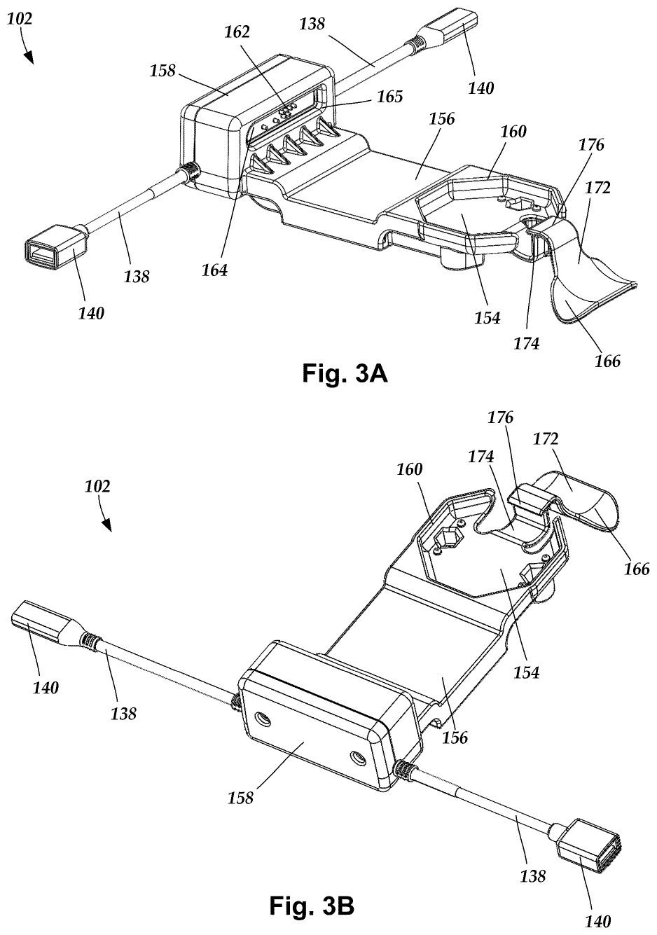

FIGS. 1A to 1E and FIG. 2 illustrate embodiments of a mount 100 for a mobile device 180 (FIG. 3A), such as a cellular or mobile phone, a smartphone, a tablet, a personal data assistant, or any other suitable mobile device. The mount 100 includes an optional dock 102, a mounting arm 104, an axle 106, a first tube arrangement 108, a second tube arrangement 110 (FIG. 1D), and an optional cover 112. The optional dock 102, mounting arm 104, axle 106, first tube arrangement 108, second tube arrangement 110 (FIG. 1D), and optional cover 112 can be made of any suitable material including, but not limited to, plastic (such as rigid plastic), metal, or the like or any combination thereof. Different components can be made of the same or different material or combination of materials.

In at least some embodiments, the mount 100 includes a dock 102, which can be any suitable dock for a mobile device including, but not limited to, a cradle (FIG. 2) or a docking button receiver (FIG. 1A). In other embodiments, the mount 100 does not include the dock 102 and the dock can be provided separately and attached to the mount. Non-limiting examples of docks (e.g., cradles) that can be part of the mount 100 are described in U.S. Pat. Nos. 9,831,904; 11,029,731; 11,076,032; 11,277,506; 11,289,864; 11,489,350; and 12,126,199; U.S. Patent Application Publication No. 2024/0361803; and U.S. patent applications Ser. Nos. 18/590,837 and 18/621,977, all of which are incorporated herein by reference in their entireties. Additional examples of docks 102 are described below. Any other suitable dock 102 can be used.

The mounting arm 104 is coupled or coupleable to the dock 102. In at least some embodiments, the mounting arm 104 is part of the dock 102. In other embodiments, the mounting arm 104 is attached or attachable to the dock 102 and may be directly attached or attachable to the dock. In at least some embodiments, the mounting arm 104 is attached to an optional dock mount base 114 that is attached or attachable (directly or indirectly) to the dock 102 using one or more fasteners 116, as illustrated in FIG. 1B. The dock mount base 114 can be a plate or the like or can be a mounting ball or any other suitable arrangement for attachment of the dock 102 to the mount 100. Non-limiting examples of dock mount bases can be found at U.S. Patents Nos. 5,845,885; 6,561,476; 7,320,50; 7,997,554; 8,454,178; 8,505,861; 9,831,904; RE 42,060; RE 42,581; and RE43,806, all of which are incorporated herein by reference in their entireties. The illustrated embodiments have a single mounting arm. It will be understood that multiple mounting arms 104 can be used.

In at least some embodiments, as illustrated in FIG. 1F, the first tube arrangement 108 includes a first tube 120, one or more axle posts 122, a lever 124, and an optional cap 126. The axle post(s) 122 extend from the first tube 120 or from the cap 126 disposed on an end of the first tube, as illustrated in FIG. 1F. The illustrated embodiment includes two axle posts 122 but any suitable number of axle posts can be used, such as one, two, three, four, or more axle posts. Each axle post 122 has an opening 123 through which the axle 106 extends or can extend.

In at least some embodiments, as illustrated in FIG. 1G, the axle 106 includes a first axle part 105 and a second axle part 107. An end of the first axle part 105 can be inserted through an opening 123 in at least one axle post 122 and then inserted into an end of the second axle part 107, which also can be inserted through an opening in at least one additional axle port. In at least some embodiments, an exterior surface of at least a portion of the first axle part 105 and an interior surface of at least a portion of the second axle part 107 are threaded so that the first axle part can be screwed into the second axle part. In at least some other embodiments, the axle 106 includes a shaft and at least one removable axle cap that is attachable to one or both ends of the axle with the axle cap being larger than the opening(s) 123 in the axle post(s) 122.

The mounting arm 104 is disposed around the axle 106 allowing the mounting arm to rotate about the axle. In at least some embodiments, a portion of the mounting arm 104 is disposed between two or more of the axle posts 122, as illustrated in FIG. 1F. This arrangement allows the mounting arm 104 and attached dock 102 to rotate about the axle 106. The range of rotation of the dock 102 about the axle 106 can be limited by the physical components (e.g., second tube arrangement 110 or first tube arrangement 108) of the mount 100. In at least some embodiments, the range of rotation of the dock 102 about the axle 106 can be limited by, for example, the shape of the axle, mounting arm 104, first tube arrangement 108, or the like or any combination thereof. For example, a rotation stop can be positioned or formed on the axle 106, mounting arm 104, first tube arrangement 108, or the like or any combination to limit rotation of the mounting arm about the axle.

The second tube arrangement 110 includes a base 128 and a second tube 130 extending from the base, as illustrated in FIG. 1F. In at least some embodiments, the second tube 130 is permanently attached to the base 128. In other embodiments, the second tube 130 is removably attached or attachable to the base 128. In at least some embodiments, the second tube 130 has an inner diameter larger than an outer diameter of the first tube 120 so that at least a portion of the first tube can be inserted into and received by the second tube 130. In at least some embodiments, the optional cap 126 has a diameter larger than an outer diameter of the second tube 130 and can act as a stop for the insertion of the first tube 120 into the second tube. In at least some embodiments, the base 128 include one or more base openings 131 (FIG. 1D) so that the mount 100 can be attached to a surface, device, or the like using fastener(s).

The lever 124 of the first tube arrangement 108 is disposed along the first tube 120 and includes a lever post 125, an end portion 127 opposite the lever post 125, and one or more fulcrum arms 129 attached to a remainder of the first tube. When the first tube 120 is inserted into the second tube 130, the interior wall of the second tube engages the end portion 127 of the lever 124 to push and bias the lever post 125 outwardly.

The second tube 130 defines at least one first cutout 132 extending around at least 25, 33, 50, 66, 75, 80, or 90% or more of the circumference of the second tube arrangement and is sized to receive the lever post 127 of the lever 124 of the first tube arrangement 108. The at least one first cutout 132 allows the dock 102 to be rotated about the central axis of the second tube 130. As the first tube 120 is pushed into the second tube 130, the interior wall of the second tube engages the end portion 127 of the leaver 124 to push the lever post 125 outward into the first cutout 132 when the lever post coincides with the first cutout. As the dock 102 is rotated about the central axis of the second tube 130 the lever post 125 travels along the first cutout.

In at least some embodiments, the second tube 130 defines at least one second cutout 134 that is sized to receive the lever post 125 and prevent or hinder rotation of the dock 102 about the central axis of the second tube. In at least some embodiments, each second cutout 134 has a size that is the same as or up to two times the size of the lever post 125 of the lever 124 of the first tube arrangement 108. As the first tube 120 is pushed into the second tube 130, the interior wall of the second tube engages the end portion 127 of the leaver 124 to push the lever post 125 outward into the second cutout 134 when the lever post coincides with the second cutout. In contrast to the first cutout(s) 132, the second cutout(s) 134 prevents or restricts rotation of the dock 102 about the central axis of the second tube 130. The provision of both first and second cutouts 132, 134 allows a user or manufacturer to select between allowing or preventing rotation of the dock 102 about the central axis of the second tube 130.

It will be understood that the lever 124 can be positioned on the second tube 130 and the first and second cutouts 132, 134 can be positioned on the first tube 120 with the first tube having an inner diameter larger than the outer diameter of the second tube.

Returning to FIG. 1A, in at least some embodiments, the mount 100 includes a cover 112, which can be a single piece of multiple pieces, such as the tubular cover 112a and the base cover 112b. In at least some embodiments, the base cover 112b has a curved, square pyramidal shape (or a flared shape), as illustrated in FIG. 1A. Any other suitable shape of the base cover 112b can be used.

In at least some embodiments, the cover 112 can include one or more holes 113 and the cap 126 (or other portions of the mount 100) and, optionally, the cover 112 can include one or more markings 115 for facilitating disengagement of the lever post 125 from the first cutout 132 or second cutout 134. Each marking 115 on the cover 112 can be aligned with one of the first or second cutouts 132, 134 and one or more of the holes 113. The marking 115 on the cap 126 (or other portion of the mount 100) is aligned with the lever 124 or lever post 125.

In operation, the first tube arrangement 108, including the cap 126, can be rotated so that a marking 115 on the cap 126 (or other portion of the mount 100) is aligned with a marking on the cover 112 (or with one of the holes 113), as illustrated in FIG. 1A. When the markings 115 are aligned, the hole 113 exposes a portion of one of the first or second cutouts 132, 134 and may expose a portion of the lever post 125. A small tool can be inserted into the hole 113 to push against the lever post 125 so that the lever post 125 disengages from the first or second cutout 132, 134. The first tube arrangement 108 can then be removed from the second tube arrangement 110. Alternatively, the first tube arrangement 108 can be partially removed and then realigned with another one of the first or second cutouts 132, 134 and pushed inwardly to engage that cutout.

A cord 138 (FIG. 1B) is attached, or attachable, to the dock 102. The cord 138 can be permanently attached to the dock 102 or can be permanently attached to the mount 100 or can be removable from both the dock and the mount. The cord 138 has at least one connector 140 for coupling to a power source, data source, or any other suitable device. The cord 138 can have another connector (not shown) for coupling to the dock 102 to provide power or data to the mobile device 180 via the mount 100 and dock 102.

In at least some embodiments, the mount 100 defines a path for the cord 138 to pass through the mount. In at least some embodiments, as illustrated in FIGS. 1B and 1F, the mount 100 includes a first opening 142a in the base 128 for entry of the cord into the mount and with the cover 112. In at least some embodiments, a strain relief 144a extends out of, or through, the first opening 142a and the cord 138 can pass through the strain relief, which reduces harm to the cord at the first opening. In at least some embodiments, the first opening 142a is defined by a post 141 extending from the base 128.

In at least some embodiments, the second tube arrangement 110 includes a window 143 in the second tube 130, through which the cord 138 can pass so that the cord can extend along the second tube and first tube 120, as illustrated in FIG. 1D. In at least some embodiments, as illustrated in FIG. 1G, the first tube arrangement 108 includes a second opening 142b and an optional second strain relief 144b so that the cord can extend out of the mount 100 for coupling attachment or coupling with the dock 102. The dock 102 can include a connector or strain relief 103 (FIGS. 2 and 1D) for receiving or coupling the cord 138.

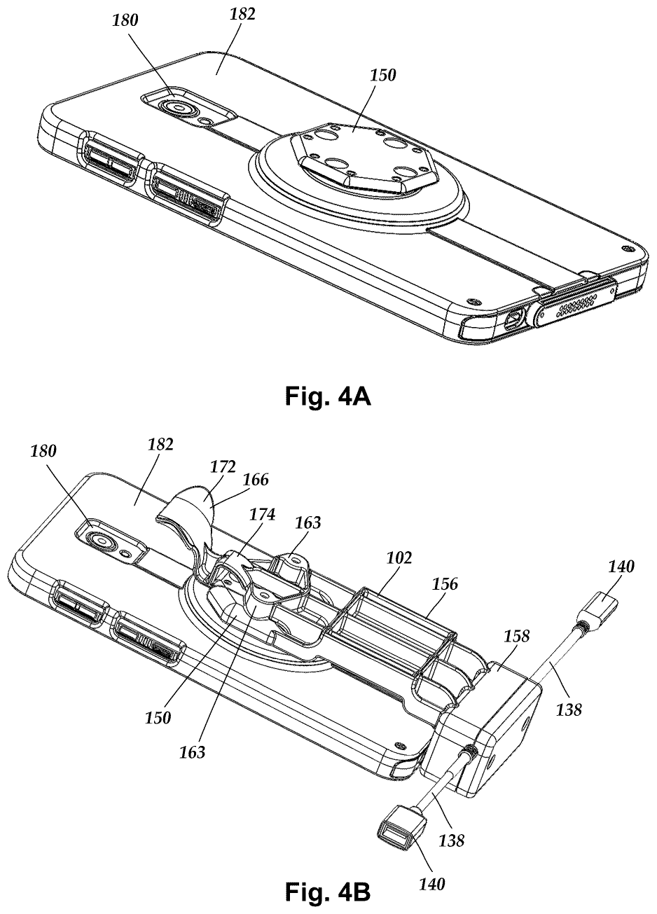

FIGS. 3A and 3B illustrate one embodiment of a dock 102 of the type illustrated in FIG. 2. In at least some embodiments, the dock 102 includes a docking button receiver 154 and optionally includes a dock base 156 and bottom device receiver 158. For example, the dock 102 of FIGS. 1A to 1I only includes the docking button receiver 154. Examples of other docks 102 can be found in the references cited above. FIG. 4A illustrates a mobile device 180 in a case 182, and a docking button 150 attached to the mobile device for engaging the docking button receiver 154 of the dock 102, as illustrated in FIG. 4B.

In at least some embodiments, the dock 102 includes one or more mounting posts 163 (FIG. 4B) or any other suitable mounting element(s) for mounting the dock 163 to the dock mount base 114 (FIG. 1B). In at least some embodiments, the docking button receiver 154 has a perimeter 160 with a lateral cross-sectional shape and the docking button 150 has a lateral cross-sectional shape complementary to the perimeter or the lateral cross-sectional shape of the docking button indentation.

The bottom device receiver 158 is attached to the cradle base 156 and may be integrally formed with (e.g., permanently attached to or permanently part of) the cradle base or may be detachable from the cradle base. In at least some embodiments, the bottom device receiver 158 includes one or more contacts 162 for making contact with contacts on the mobile device 180 (FIG. 2A) or a case 182 (FIG. 2A) containing the mobile device. Any arrangement of the contacts 162 can be used including, but not limited to, an arrangement of the contacts in one or more rows. When the arrangement includes two or more rows, the contacts in the rows can be aligned or staggered relative to each other. In other embodiments of the dock 100, the contacts 162 can be positioned anywhere in or on the dock such as, for example, in or on the docking button receiver 154, as illustrated in FIG. 1A. In at least some embodiments, the contacts 162 are pogo pins or other biasing contacts that can move up or down relative to the bottom device receiver 158 or docking button receiver 154.

The contacts 162 make electrical contact with contacts on the mobile device 180 (FIG. 4A) or a case 182 (FIG. 4A) disposed on the mobile device when the mobile device is inserted into (e.g., received by) the dock 102. Examples of cases with contacts include, but are not limited to, the cases, covers, or skins described in U.S. Patents Nos. 9,195,279; 9,331,444; 9,529,387; 9,602,639; 9,632,535; 9,706,026; 10,050,658; 10,054,984; 10,389,399; 10,454,515; 10,630,334; 10,812,643; and 11,289,864, all of which are incorporated herein by reference in their entireties. The contacts 162 in the dock 102 can be used to transfer power to the mobile device 180 (FIG. 4A) from a power source, transfer data between the mobile device and a data source, or any combination thereof. In at least some embodiments, the bottom device receiver 158 which includes a recess 164 surrounded by a rim 165 that may facilitate retention of the mobile device in the dock 102. In at least some embodiments, the recess 164, rim 165, and contacts 162 form a female connector.

A dock 102 can include a latch 166 for engaging the docking button 150. In at least some embodiments, the latch 166 includes a handle 172, a resilient or flexible latch arm 174 coupled to the cradle base 156, and a latching lip 176 configured to engage the docking button 150. Any other suitable latch can be used. In at least some embodiments, the indentation perimeter 160 of the docking button indentation 154 is interrupted by, or partially defined by, the latch 166 (e.g., by the latching lip 176) or elsewhere, as illustrated in FIGS. 3A and 3B. In at least some embodiments, the indentation perimeter 116 of the docking button indentation 154 includes open spaces adjacent to the latch 166. In these embodiments, the shape of the indentation perimeter 116 is considered to be the shape as if these open spaces were filled in.

In at least some embodiments, the latch 166 is manually moveable between a latched position and an unlatched position. In at least some embodiments, the latch 166 is biased toward the latched position. In the latched position, the latch 166 directly engages the docking button 150 for retention of the mobile device 180 on the dock 102. In the unlatched position, the latch 166 disengages from, or is not engaged with, the docking button 150 to permit loading or unloading of the mobile device 180 on the dock 102. In at least some embodiments, the latch 166 is operable using the handle 172 to move the latch between the latched position and the unlatched position. In at least some embodiments, a docking button 150 pushing against the latching lip 176 of the latch 166 can move the latch from the latched position to the unlatched position for insertion of the docking button 150 into the docking button indentation 154 but pulling the docking button 150 against the latching lip 176 does not result in releasing the docking button 150 from the docking button indentation 154. In at least some embodiments, operating the latch handle 172 can result in the resilient latch arm 174 flexing to the unlatched position. In at least some embodiments, the resilient latch arm 174 is biased to maintain the latch 166 in the latched position.

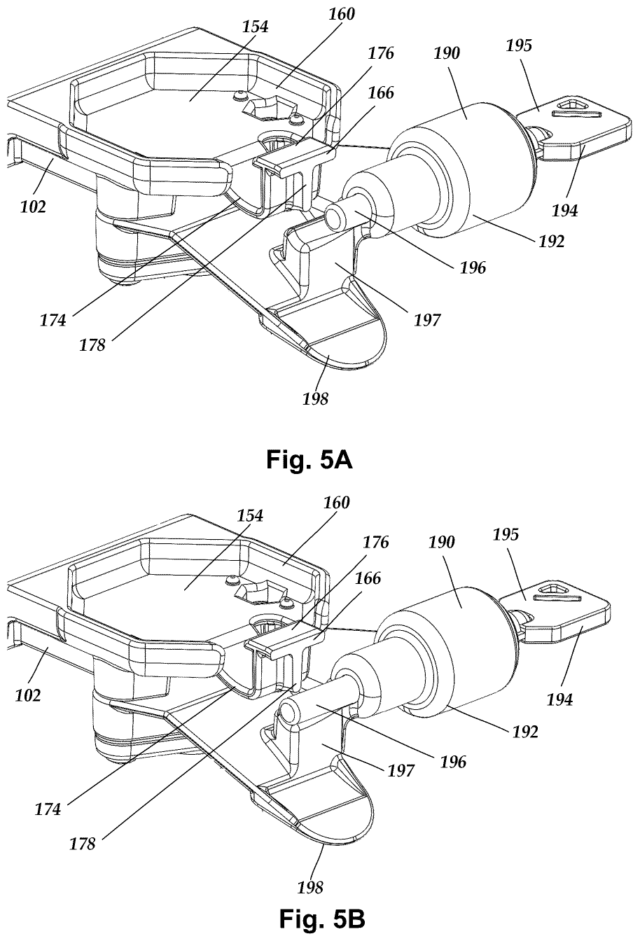

In at least some embodiments, a latch lock 190 is part of, or coupled to, the dock 102, as illustrated in FIGS. 5A and 5B. The latch lock 190 is arranged, when in a locked position, to prevent moving the latch 166 to the unlatched position to facilitate retention of the mobile device 180 on the dock 102. The illustrated embodiment of the latch lock 190 includes a lock body 192, a lock actuator 194, and a latch bar 196. FIG. 5A illustrates the latch lock 190 in the unlocked position with the latch bar 196 retracted allowing the latch 166 to move to the unlatched position. FIG. 5B illustrates the latch lock 190 in the locked position with the latch bar 196 extended to hinder the latch 166 from moving to the unlatched position.

In the illustrated embodiment, the latch 166 includes a lock engagement feature 178 that engages the latch bar 196 when the latch lock 190 is in the locked position to halt moving the latch to the unlatched position. In at least some embodiments, the lock body 192 includes a bar platform 197 that a) supports the latch bar 196 when the latch bar 196 is extended or b) provides a stop to movement of the latch 166 while allowing the latch 166 to move to the unlatched position when the latch lock 190 is in the unlocked position or c) both features a) and b). In at least some embodiments, the lock body 192 includes a latch stop 198 that engages the latch handle 172 as the latch handle moves to the unlatched position to resist bending the latch handle too far and possibly damage the latch 166. In at least some embodiments, the latch stop 198 may also provide a surface that the user can use to pinch the latch handle 172 and latch stop 198 between thumb and finger (or two fingers) to move the latch 166 to the unlatched position.

Any suitable lock actuator 194 can be used. In the illustrated embodiment, the lock actuator 194 is a rotating key actuator which extends or retracts the latch bar 196 as the key 195 is rotated. Other actuators include, but are not limited to, other rotating actuators, a push-button actuator, or the like or any combination thereof.

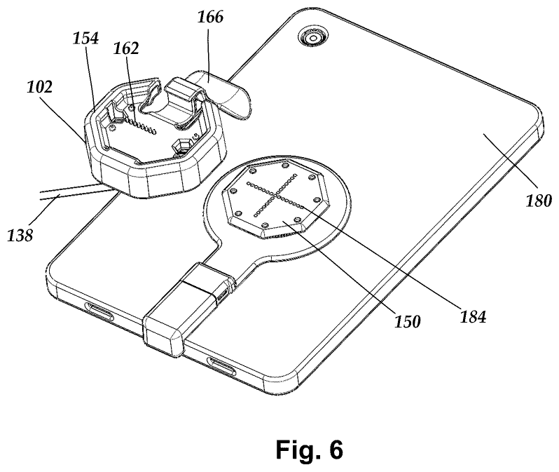

FIG. 6 illustrates one embodiment of a dock 102 of the type illustrated in FIG. 1A. The dock 102 includes a docking button receiver 154, one or more contacts 162 for making contact with the contacts 184 on the docking button 150, and an optional latch 166, each of which are the same or similar to the same elements of the dock 102 of FIGS. 3A and 3B.

The above specification provides a description of the manufacture and use of the invention. Since many embodiments of the invention can be made without departing from the spirit and scope of the invention, the invention also resides in the claims hereinafter appended.

What is claimed as new and desired to be protected by Letters Patent of the United States is:

1. A mount for a mobile device, the mount comprising:
a dock configured for coupling to the mobile device;
a mounting arm coupled to the dock;
an axle coupled to the mounting arm and configured for rotation of the dock about the axle;
a first tube arrangement comprising a first tube and at least a pair of axle posts extending from the first tube, wherein each of the axle posts defines an axle opening for receiving the axle with a portion of the mounting arm disposed around the axle and between the axle posts;
a second tube arrangement comprising a base and a second tube extending from the base; and
a lever disposed along a first one of the first tube or the second tube, wherein the lever comprises a first end portion with a lever post disposed along the first end portion, a second end portion opposite the first end portion, and at least one fulcrum arm coupled to the first one of the first tube or the second tube and disposed between the first end portion and the second end portion of the lever;
wherein a second one of the first tube or the second tube defines a first cutout extending around at least 50% of a circumference of the second one of the first tube or the second tube, wherein the first cutout is configured to receive the lever post and permit travel of the lever post along the first cutout;
wherein the first one of the first tube or the second tube is configured for insertion into the second one of the first tube or the second tube to receive the lever post in the first cutout, wherein the second one of the first tube or the second tube is configured to engage the second end portion of the lever to bias the lever post outward into the first cutout, wherein the mount is configured for the dock to be rotatable, relative to the base of the second tube arrangement, about two different axes when the lever post is received in the first cutout.

2. The mount of claim 1, wherein the second one of the first tube or second tube further defines a second cutout configured to receive and hold the lever post at a selected position along the circumference of the second one of the first tube or the second tube, wherein the mount is configured for the dock to be rotatable, relative to the base of the second tube arrangement, about one axis when the lever post is received in the second cutout.

3. The mount of claim 1, wherein the dock defines a docking button indentation configured to receive a docking button disposed on, or coupled to, a back surface of the mobile device or of a case containing the mobile device.

4. The mount of claim 1, wherein the dock comprises a cradle configured for receiving the mobile device.

5. The mount of claim 1, further comprising a cover configured to cover at least a portion of the second tube arrangement.

6. The mount of claim 5, wherein the cover defines an opening configured for accessing the lever post of the lever through the cover when the lever post is rotated to align with the opening.

7. The mount of claim 1, wherein the axle comprises a first portion and a second portion, wherein the first portion receives a part of the second portion to form the axle.

8. The mount of claim 1, further comprising a cable extendable through a portion of the mount for coupling the mobile device to a power or data source.

9. A system, comprising:
the mount of claim 1; and
the mobile device.

10. A mount for a mobile device, the mount comprising:
a mounting arm configured for coupling a dock thereto;
an axle coupled to the mounting arm and configured for rotation about the axle;
a first tube arrangement comprising a first tube and at least a pair of axle posts extending from the first tube, wherein each of the axle posts defines an axle opening for receiving the axle with a portion of the mounting arm disposed around the axle and between the axle posts;
a second tube arrangement comprising a base and a second tube extending from the base; and
a lever disposed along a first one of the first tube or the second tube, wherein the lever comprises a first end portion with a lever post disposed along the first end portion, a second end portion opposite the first end portion, and at least one fulcrum arm coupled to the first one of the first tube or the second tube and disposed between the first end portion and the second end portion of the lever;
wherein a second one of the first tube or the second tube defines a first cutout extending around at least 50% of a circumference of the second one of the first tube or the second tube, wherein the first cutout is configured to receive the lever post and permit travel of the lever post along the first cutout;
wherein the first one of the first tube or the second tube is configured for insertion into the second one of the first tube or the second tube to receive the lever post in the first cutout, wherein the second one of the first tube or the second tube is configured to engage the second end portion of the lever to bias the lever post outward into the first cutout, wherein the mount is configured for the dock, when coupled thereto, to be rotatable, relative to the base of the second tube arrangement, about two different axes when the lever post is received in the first cutout.

11. The mount of claim 10, further comprising the dock configured for coupling to the mobile device, wherein the dock is removably coupled or coupleable to the mounting arm.

12. The mount of claim 11, wherein the dock defines a docking button indentation configured to receive a docking button disposed on, or coupled to, a back surface of the mobile device or of a case containing the mobile device.

13. The mount of claim 11, wherein the dock comprises a cradle configured for receiving the mobile device.

14. The mount of claim 10, wherein the second one of the first tube or second tube further defines a second cutout configured to receive and hold the lever post at a selected position along the circumference of the second one of the first tube or the second tube, wherein the mount is configured for the dock, when coupled thereto, to be rotatable, relative to the base of the second tube arrangement, about one axis when the post is received in the second cutout.

15. The mount of claim 10, further comprising a cover configured to cover at least a portion of the second tube arrangement.

16. The mount of claim 15, wherein the cover defines an opening configured for accessing the lever post of the lever through the cover when the lever post is rotated to align with the opening.

17. The mount of claim 10, wherein the axle comprises a first portion and a second portion, wherein the first portion receives a part of the second portion to form the axle.

18. The mount of claim 10, further comprising a cable extendable through a portion of the mount for coupling the mobile device to a power or data source.

19. A system, comprising:
the mount of claim 10; and
the mobile device.

20. The system of claim 19, further comprising the dock configured for coupling to the mobile device, wherein the dock is removably coupled or coupleable to the mounting arm.
